(19) United States
(12) Patent Application Publication
(10) Pub. No.: US 2022/0243088 A1
(43) Pub. Date: Aug. 4, 2022

(54) REMOVABLE FLOOR CARE COMPOSITION WITH RESISTANCE TO ALCOHOL

(71) Applicant: Omnova Solutions Inc., Beachwood, OH (US)

(72) Inventors: James H. Gaston, II, Rockford, TN (US); Glen B. Thomas, Akron, OH (US); William J. Brown, Mogadore, OH (US)

(73) Assignee: Omnova Solutions Inc., Beachwood, OH (US)

(21) Appl. No.: 17/622,483

(22) PCT Filed: Jun. 23, 2020
(86) PCT No.: PCT/US2020/039205

§ 371 Date: Dec. 23, 2021

Related U.S. Application Data
(60) Provisional application No. 62/866,418, filed on Jun. 25, 2019.

(51) Int. Cl. C09D 133/06; C08F 220/18; C08F 212/10; C09D 125/14; C09D 7/45; C09D 7/20

(52) U.S. Cl. CPC C09D 133/064; C08F 220/1804; C09D 7/20; C09D 125/14; C09D 7/45; C08F 212/10

(57) ABSTRACT

A floor care composition includes pre-made polymer particles in a liquid vehicle as well as a non-ionic crosslinking agent. The polymer particles include a relatively narrow ratio of hydro-philic to hydrophobic regions or components, a generally non-uniform morphology, and a relatively small number of carboxyl groups. When used in floor care formulations with the correct amount and type of crosslinking compounds, a resulting floor care finish can be both resistant to alcohols such as ethanol and readily removable.

### CROSS-REFERENCE TO RELATED APPLICATION

This application is a National Phase application of International Application No. PCT/US2020/039205, filed 23 Jun. 2020 which claims priority to and the benefit of U.S. provisional patent application No. 62/866,418, filed 25 Jun. 2019, the entire disclosure of each of which is incorporated herein by reference for all purposes.

### BACKGROUND OF THE INVENTION

Polymeric coatings are used in paints, wood finishes, printed surfaces, photographs, floor care products, waxes, polishes, and the like, to coat and protect surfaces, regardless of orientation (e.g., vertical, horizontal, or otherwise).

Floor care products require periodic application of a liquid floor care composition that contains or produces a polymeric film or layer. This protective layer or coating desirably exhibits properties such as resistance to scratching and scuffing, resistance to marking from shoes, resistance to liquids (including water), strong adhesion to the substrate, and gloss and transparency (e.g., lack of hazing).

Floor care protective products often are classified as being either one-component (1K) or two-component (2K) systems. In the former, one or more pre-made solid polymer materials are dissolved, dispersed, or suspended in an organic or aqueous liquid and, after application to a floor, form a film (coalesce) as the carrying liquid evaporates. In the latter, two or more monomeric components remain liquid until applied, whereupon they react to create an in-place polymeric film.

Many 2K systems result in a coating which provides excellent performance properties but is costly and difficult to remove if damaged or compromised. Conversely, 1K systems typically provide acceptable performance properties at a lower cost and can be readily removed or repaired on an as-needed basis.

One performance metric where 2K systems clearly have outpaced 1K systems is resistance to alcohols. As the use of ethanol-containing hand sanitizing gels and foams has grown in schools, hospitals, and the like, such institutions have learned to expect white or opaque spots forming in areas where drops of alcohol-containing sanitizer have fallen and compromised the protective floor coating. Although this can be mitigated by immediately cleaning areas around dispensers, the ubiquity of such dispensers and the relative dearth of maintenance personnel means that 1K-type floor protective coatings must be removed and reapplied on a more frequent basis.

Manufacturers of 1K-type floor care compositions have tried a number of changes and reformulations to provide a level of alcohol resistance that such institutions find acceptable.

That which remains desirable is a floor care composition capable of providing a protective coating that has acceptable visual and performance (i.e., resistance to abrasion, scuffing, etc.) characteristics, that can be removed easily using inexpensive chemicals and techniques, and that provides an acceptable level of resistance to alcohols, particularly ethanol (such as can be found in many hand sanitizer gels) and, to a lesser extent, isopropanol.

### SUMMARY OF THE INVENTION

Provided herein is a floor care composition which includes pre-made interpolymer particles in a liquid vehicle, typically water, as well as a non-ionic crosslinking agent. The particles include a relatively narrow ratio of hydrophilic to hydrophobic regions or components and a generally non-uniform morphology. The interpolymers in those particles contain carboxyl groups, although in an amount that is lower than is present in most carboxylated polymers typically employed in floor care compositions.

Embodiments of a floor care composition provide a removable protective coating that has acceptable mechanical durability properties such as resistance to scratching and scuffing, resistance to heel marks, and strong adhesion to the flooring substrate yet, advantageously, also exhibit good resistance to alcohol, e.g., maintenance of acceptable visual properties when subjected to staining or marring by alcohol-containing compositions.

Also provided are methods for making and using this type of floor care composition, as well as protective floor finishes made from the composition.

The detailed description that follows describes still other aspects of the present invention. To assist in understanding that description, certain definitions are provided immediately below, and these are intended to apply throughout unless the surrounding text explicitly indicates a contrary intention:
“polymer” means the polymerization product of one or more monomers and is inclusive of homo-, co-, ter-, tetra-polymers, etc.;
“mer” or “mer unit” means that portion of a polymer derived from a single reactant molecule (e.g., ethylene mer has the general formula —CH₂CH₂—);
“copolymer” means a polymer that includes mer units derived from two reactants, typically monomers, and is inclusive of random, block, segmented, graft, etc., copolymers;
“interpolymer” means a polymer that includes mer units derived from at least two reactants, typically monomers, and is inclusive of copolymers, terpolymers, tetra-polymers, and the like;
“pph” means parts per hundred total monomers on a weight basis; and
“aqueous” refers to any liquid blend or mixture that includes water as a component, typically as the solvent or medium.

Throughout this document, unless the surrounding text explicitly indicates a contrary intention, all values given in the form of percentages are weight percentages, and all descriptions of minimum and maximum values for a given property further include ranges formed from each combination of individual minimum and individual maximum values.

A numerical limitation used herein includes an appropriate degree of uncertainty based on the number of significant places used with that particular numerical limitation. For example, “up to 5.0” can be read as setting a lower absolute ceiling than “up to 5.”

At various points, this document refers to glass transition temperature (T_{g}), both with respect to overall polymers or segments thereof. In either case, T_{g} is that calculated using the well-known Fox equation: see T. G. Fox, Bull. Am. Phys. Soc., vol. 1, p. 123 (1956).

The relevant teachings of all patent documents mentioned throughout are incorporated herein by reference.

### DETAILED DESCRIPTION OF THE INVENTION

As described above, protective floor coatings can be provided from floor care compositions that contain pre-made polymer particles which coalesce to form a film (1K system) or two or more monomeric components which react so as to provide an in situ polymeric film (2K system). This invention relates to 1K-type systems as well as coatings provided therefrom.

The paragraphs which follow first describe a polymerization process capable of providing the desired interpolymer particle component of the floor care composition, the incorporation of those particles in a floor care composition, and a protective floor coating provided from a floor care composition.

U.S. Pat. No. 4,150,005 teaches the sequential polymerization of different classes of monomers to provide polymer particles which have a calculated glass transition temperature (T_{g}) above ˜20°. A latex of these polymers has a low viscosity, but the polymers are able to form films at a temperature which is low relative to the overall polymer's calculated T_{g}. The patent refers to the polymer particles as being “internal!y plasticized.”

The multistage technique used to make internally plasticized particles results in two types of polymer chains. The polymers resulting from the first stage (referred to here as A) are hydrophilic and have a relatively low T_{g}, while the polymers resulting from the second stage (referred to here as B) are less hydrophilic and have a higher T_{g}.

Even though essentially sequential stages occur in an emulsion polymerization environment, with the product of the second stage (B) being produced in the presence of the product of the first stage (A), the B stage product does not necessarily overlay or surround the A stage product.

When polymer particles containing styrene mer are subjected to a ruthenium stain, areas that contain high amounts of styrene mer will preferentially darken. When an interpolymer particle provided according to the process described herein undergoes such staining and then is subjected to transmission electron microscopy, the resulting image shows a generally lighter central or core area surrounded by a darker shell. Nevertheless, the core appears to contain some darker regions, which suggests that a portion of the polymers making up the shell have penetrated into the core. Further, the shading of the shell is not as dark as might be expected were it comprised solely or primarily of styrene mer. All of this suggests that some of the mer that might be expected to be present solely as a result of the first stage (A) have migrated into or interpenetrated the product of the second stage (B).

Thus, the structure of some, if not the majority, of the resulting polymer particles appear not to be truly core-shell. Instead, at least some of the products of the second stage (Bs) are believed to interrupt or even penetrate the products of the first stage (As), resulting in particles having non-uniform, non-homogeneous morphologies.

Regardless of the degree (if any) of penetration of Bs into As, an important feature of the resulting polymer particles is the ratio of A to B therein.

The paragraph bridging columns 7-8 of U.S. Pat. No. 4,150,005 indicates a preference for an approximately 50:50 ratio of A:B, with A constituting from 20-80% (w/w), from 30-70° (w/w), or from 40-60%) (w/w) of the total polymer. (Because such ethylenically unsaturated monomers are so susceptible to polymerization under the conditions both there and here, percentages in the final polymer particles can be approximated quite well by the weight percentages of the monomer feeds, which is how the '005 patent addresses the issue in its examples. If an actual analysis of first stage polymers were undertaken, some particles might have a ratio higher than the stated upper limit while other particles might have a ratio lower than the stated lower limit, but the mean of all particles will fall within that particular range).

In the floor care composition of the present invention, the interpolymer particles must have more A than B. Progressively more preferred ranges of weight ratios of A to B are 52:48 to 72:28, 54:46 to 69:31, 56:44 to 66:34, 58:42 to 64:36, 59:41 to 63:37, 60.5:39.5 to 62.5:37.5, and 61:39 to 62:38.

The interpolymer particles are provided using an emulsion polymerization technique, meaning that constituent monomers are polymerized in an aqueous environment in the presence of surfactants. Because emulsion polymerizations have been conducted for many decades, the general conditions and techniques are familiar to the ordinarily skilled artisan. For additional information, the interested reader can refer to any of a variety of patents including, for example, the aforementioned '005 patent as well as patents cited therein as well as later patents citing those documents.

At least one dispersing agent, typically a surfactant, is used to emulsify those monomers which are not soluble in the aqueous polymerization medium. Each category of surfactant—nonionic, anionic, cationic and zwitterionic —can be used. Because the monomers being polymerized in the description which follows include so-called acidic monomers (i.e., ethylenically unsaturated compounds which include a carboxyl functional group), anionic and/or nonionic surfactants tend to be preferred. The amount(s) of surfactant(s) employed generally is less than 10% based on the total weight of monomers to be added, commonly from ˜0.1 to ˜5%, typically from ˜0.5 to ˜2.5% (all percentages here being w/w).

One or more chain transfer agents (CTAs), such as but not limited to mercaptans and polyhalogen compounds, also can be present during the polymerization process. Typically, CTAs are used to limit polymer molecular weight; however, in the present situation, CTAs are not necessary to obtain desirable properties of the final polymer product

Another optional ingredient is a pH adjusting/buffering compound such as, for example, sodium bicarbonate.

If desired, some or all of the coalescing agent (solvent) can be included in the reaction vessel before or at the time of polymerization. Any of a variety of glycol ethers represent exemplary coalescing agents.

Typically, after water has been charged to a suitable reaction vessel, the dispersing agent(s) and any desired optional ingredients are added. This initial addition typically occurs at or near ambient temperature, although that is not required. The contents of the vessel can be stirred or agitated.

One or both of the monomers and the catalyst system (initiator plus, optionally, accelerator) typically is/are added after the initial addition, described above.

Often, this subsequent addition occurs after the temperature of the reaction vessel has been elevated. Reaction vessels often have integral means for introducing heat to or removing heat from the contents of the vessel. After the initial addition, heat can be introduced to the vessel so that its internal temperature rises to ˜50° to ˜95° C., typically from ˜80° to ˜90° C., prior to introduction of the monomers and/or catalyst system. (The temperature at which the contents of the reaction vessel are maintained depends on a variety of factors including, for example, the composition of monomers and the particular catalyst system employed.)

The catalyst system can be added prior to the monomers so that arriving monomeric compounds encounter free radicals very soon after being introduced to the vessel. Alternatively, particularly where a seed polymer (described below) is desired for purposes of particle size consistency, a portion of monomer can be added to the vessel first prior to introduction to any initiator, primarily because monomer addition is more likely to have a significant impact on internal reactor temperature than will addition of initiator. In situations where (semi)-continuous feeds of monomer and initiator are employed, both typically arrive essentially simultaneously in the reaction vessel.

Any of a variety of persulfates constitute a preferred type of commonly employed initiators, optionally in the presence of an accelerator such as a metabisulfite or thiosulfate. The catalyst system generally is present at less than 2% (w/w) based on the total weight of monomers (all stages) to be added. Commonly employed amounts of initiator(s) range from ˜0.05 to ˜1.5% (w/w), typically from ˜0.25 to ˜1.25% (w/w).

The manner in which monomeric compounds are introduced to the reaction vessel can impact polymer particle size.

A small charge of monomers can be used to grow so-called seed polymers, although this can be foregone in favor of a so-called running start polymerization. Generally, inclusion of a seed step can enhance particle size consistency, a factor that can vary greatly in terms of relative importance from one manufacturer to another.

Additionally or alternatively, the monomer(s) can be pre-emulsified (i.e., a portion of the dispersing agent mentioned previously can be omitted from the reaction vessel and added to the monomeric compounds prior to their introduction to the reaction vessel).

In the present case, smallest particle sizes have been obtained by introducing neat monomers via a seed-forming technique, but the variation in sizes of the particles attributable to introduction technique (e.g., pre-emulsification versus neat) has not been observed to significantly impact any of the desired performance characteristics of either the composition or resulting protective coating.

If particle size is deemed to be important, the aforedescribed factors, as well as other considerations such as type and amount of surfactant(s), can be used to adjust or fine tune the average diameter of particles resulting from the A products (which, in turn, has the greatest impact on overall particle size). Such process considerations are familiar to ordinarily skilled artisans.

In addition to use of a seed polymer, another option is to tailor the addition of the monomer(s) in the initial stage. In other words, rather than a bulk addition technique, the monomer feed can he continuous, discontinuous and/or tapered, i.e., compositionally varied over time.

The monomers involved in this first addition are discussed below.

Stirring or other agitation of vessel contents can be continued or, if not done previously, begun. Stirring typically is maintained during the entire time that polymerization of the A stage monomers is underway. Paddle shape and size, stirrer speed, overall energy input, and the like all can be tailored or adjusted based on reactor size and geometry as well as the needs of a given polymerization.

After the initial addition of monomers is substantially complete, those monomers are permitted to polymerize to substantial completion, i.e., less than 10%, preferably less than 5%, more preferably less than 2.5%, and most preferably less than 1% of those monomers remain in the reaction vessel. This can be determined by analytical techniques (e.g., gravimetric analysis or gas chromatography) or, more commonly, merely by permitting a sufficient amount of time to pass, e.g., 900-3600 seconds. If a continuous or tapered addition is employed, this might involve the passage of a set amount of time, e.g., 900-1200 seconds after the addition has finished, to ensure that all monomers have had an opportunity to polymerize.

The second addition of monomers can be initiated at any point after the desired degree of conversion of the monomers from the initial addition has been achieved. The second addition can be performed using the same techniques as described above in connection with the initial addition, although use of a seed polymer in connection with this addition is superfluous because the desire is to permit the B products to form or build on the A products already in the reaction vessel.

Changing the temperature of the contents of the reaction vessel typically is not required, although doing so certainly is contemplated.

As was the case with the first addition, batch, continuous, discontinuous, tapered, etc., techniques all are possible with this second addition.

The monomers involved in this second addition are discussed below, after a discussion of the monomers involved in the first addition.

The polymer products of the initial (A) monomer addition(s) provide two important features to the overall interpolymer particles and, by extension, to the overall floor care composition, which help it to meet the desired balance of performance characteristics.

The first of these relates to the relative hardness of the A polymers, specifically, the calculated T_{g} of the chains/segments resulting from the A addition(s) must be less than 40° C., preferably from ˜20° to ˜37.5° C., more preferably from 25° to 36° C., and most preferably from 30° to 35° C. (This calculated T_{g} can be determined as described above and need not be the value determined by an actual measurement of T_{g} conducted on A polymers.) This characteristic results from using primarily monomers that form so-called “soft” homopolymers.

The second feature relates to the number of carboxyl groups provided in the A polymers. As becomes apparent below, all carboxyl groups in the overall polymer particles comes from the A addition(s). Because carboxyl groups are involved in ionic crosslinking reactions, typically with metal ions such as Ca⁺² or Zn⁺², in many floor care compositions, the amount of carboxyl groups in polymer particles typically is kept as high as possible, or at least practical, so as to maximize physical properties such as abrasion resistance and resistance to heel marks; most commercial polymers intended for use with ionic crosslinkers in floor care compositions possess more than 9 pph, often at least 10 pph, typically at least 11 pph, and occasionally 12 or more pph.

Here, however, the total amount of carboxyl group-containing mer (based on overall dry polymer weight) preferably is maintained below 9 pph. The minimum amount of such mer is at least 6 pph and often at least 7 pph. (Either of these minimum amounts can be combined with the foregoing maximum to create a range.) A preferred amount of such mer is 8 pph ±5%.

Carboxyl groups result from inclusion of monomers represented by the formula

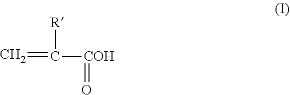

where R′ is H or a methyl group, i.e, acrylic acid or methacrylic acid. As explained above, the amounts of general formula (I)-type monomer(s) can vary widely, although it typically constitutes from ˜7.5 to ˜17.5% (w/w), more typically from ˜10 to 15° (w/w) of the total amount of monomers employed in the initial addition.

If the two foregoing features are maintained, the identity and relative amounts of other monomers used in the initial (A) addition can vary widely. However, a corollary of the second feature is that the result of the A addition cannot be a homopolymer, i.e., it will be an interpolymer.

A preferred class of monomers which can be employed in the initial addition are (meth)acrylates, represented by the general formula

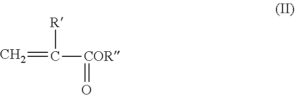

where R′ is defined as above and R″ represents a C₁-C₁₈ alkyl group, preferably a C₁-C₈ alkyl group, more preferably a C₁-C₄ alkyl group. Non-limiting examples of compounds defined by general formula (II) include methyl (rneth)acrylate, ethyl (meth)acrylate, propyl (meth)acrylate, isopropyl (meth)acrylate, butyl (meth)acrylate, isobutyl (meth)acrylate, sec-butyl (meth)acrylate, hexyl (rneth)acrylate, octyl (meth)acrylate, etc., as well as substituted variants such as 2-ethyl-hexyl (meth)acrylate. Two or more members of this group can be used in combination.

Other types of unsaturated compounds that can be included in the initial (A) monomer charge include any of a variety of vinyl esters and α-olefins.

The initial addition also can include small amount(s) of vinyl aromatic compounds, primarily styrene, α-methyl styrene, and halogenated variants. Although the homopolymers of such monomers generally are considered to be “hard,” the presence of mer derived from such monomers is preferred to increase performance characteristics such as abrasion resistance as well as, perhaps, interactivity with the polymers resulting from the second (B) addition. The amounts of these monomer(s) can vary widely, although it/they generally constitute no more 5%, typically from 1 to 4%, more typically from 1.5 to 3.5%, and commonly 2.5±0.75% (all w/w) of the total amount of monomers employed in the initial addition.

To the A polymer products of the initial monomer additions is introduced a second monomer addition. These second (B) stage monomers generally provide homopolymers that have much higher T_{g} values, e.g., at least 75° C., preferably at least 80° C., more preferably at least 85° C., and most preferably at least 90° C.

The polymer chains or segments resulting from the B monomers preferably do not include any carboxyl groups, i.e., as described above, all of the carboxyl groups in the polymer particles preferably result from one or more of the A monomers.

A preferred class of monomers which can be employed in the B addition is styrene and its derivatives, e.g., α-methyl styrene, any of a variety of halogenated styrenes, divinylbenzene, etc. (Divinylbenzene and other difunctional monomers can result in crosslinking beyond that which results from the process described below. Accordingly, the amount(s) of such difunctional monomers preferably is/are limited unless and until the polymerization process is tailored to account for their presence.) Styrene can be used as the sole B monomer or can be blended with or sequenced with other appropriate unsaturated compounds.

Other potentially useful B monomers include, but are not limited to, acrylonitrile, methyl methacrylate, butyl acrylate, isobutyl methacrylate, and the like. These can be used individually or in combination.

In some embodiments, styrene can be omitted in favor of two or more other B monomers, e.g., acrylonitrile and methyl methacrylate.

As described above, polymer particles resulting from the foregoing process must include more portions resulting from A additions than from B additions. Because the second stage (B) monomers, like the A monomers, tend to polymerize at or near 100% conversion, the aforementioned ratios can be accurately estimated by adjusting the feed of first vs. second stages.

The B addition of the polymer particles consisted almost entirely of styrene yet, as described above, ruthenium shading of the shell is not as dark as is expected for a styrenic polymer. Thus, some of the chains/segments from the A addition, which normally would be expected to present solely in the core, might have migrated into or interpenetrated the shell, resulting in some, if not the majority, of resulting polymer particles having a structure that is not truly core-shell. Instead, the particles seemingly possess non-uniform, non-homogeneous morphologies.

To achieve the desired level of alcohol resistance, good coalescence of polymer particles into a uniform film is important. Polymers that include mer resulting from A addition tend to coalesce better than the polymers that include mer resulting from B addition. Typically, this might seem to argue for ensuring that the former constitute the outermost portions of the polymer particles. However, in practice, this has not been found to be necessary and, at least in some respects, disadvantageous.

At least some of the A chains/segments seem to burrow from the “core” into or through the B chains/segments so as to reach the exterior of the polymer particles, despite the fact that the “shell” has been created subsequently. The fact that at least some of the A chains/segments are at or very near the surface appears to be borne out by the fact the observed mini mum film forming temperature (MFFT) is similar to the calculated (theoretical) T_{g} of the A interpolymers and lower than that the theoretical T_{g} of the B polymers.

The ability to provide the interpolymers resulting from the A addition prior to the polymers resulting from the B addition is advantageous because the chains/segments resulting from the former, which include carboxyl groups, tend to polymerize at least in part in the aqueous phase as opposed to solely in micelles. This tendency can increase the viscosity of the overall emulsion, especially as the solids content in the reactor increases. By polymerizing the A monomers first, processing is simplified (due to lower viscosities being maintained) yet, because the resulting polymer particles are not true core-shell particles, at least some of the A segments are at or near the particle surface, thereby permitting the desired coalescence and low MFFT.

After the second (B) addition of monomers is substantially complete, those monomers are permitted to polymerize to substantial completion, i.e., less than 10%, preferably less than 5%, more preferably less than 2.5%, and most preferably less than 1% of those monomers remain in the reaction vessel. (The degree of remaining monomers can be determined as described previously.)

The total amount of solids (e.g., total solids by weight) can range from 34 to 42%, preferably from 36 to 40%, from 37 to 39%, or even 38±0.5% (all w/w, based on the total weight of the composition).

If desired due to regulatory or other considerations, post-polymerization monomer reductions can be achieved by adding aliquots of oxidizing and reducing agents. This optional post-polymerization monomer reduction is familiar to the ordinarily skilled artisan.

To eliminate the need for pre-usage additions, post-polymerization additions can be made to the reaction vessel. Common post-adds include, but are not limited to, ionic cross-linking metal atom-containing compounds (e.g., zinc ammonium carbonate, calcium acetate, etc.), one or more crosslinkers that do not contain metal atoms or ions, and plasticizer(s). Advantageously, the tendency of the polymer particles to exhibit a type of internal plasticization (where the harder shell (B) portion is interrupted by the softer core (A) portion) means that the amount of external plasticizer is less than that which would be expected.

To achieve the desired level of alcohol resistance in the ultimate floor care composition, inclusion of a non-metallic crosslinker has been found to be important. This typically requires use of a compound that can form covalent bonds at opposite ends of the molecule. A class of such compounds are reactive silanes, which generally include a silane group and a separate functional group that can react with an acid, vinyl, or other reactive group of the polymer (e.g., a vinyl, epoxy, amine, etc., group). Useful reactive silane compounds can be represented by the general formula Z-R¹-Si(R²)₃ where Z is a reactive functional group, R¹ is a divalent linking group, preferably a hydrocarbylene (e.g., alkylene) group, optionally containing one or more heteroatoms such as 0, S, P, N, etc., and each R² independently is an alkyl or alkoxy group, with the proviso that at least one R² is an alkoxy group; in some embodiments, preferably at least two R² groups constitute alkoxy groups. Non-limiting examples of reactive silane compounds include vinyltrialkoxysilanes such as vinyltrimethoxysilane and vinyltriethoxysilane, β-(3,4-epoxycyclohexyl) ethyltriethoxysilane, any of a variety of epoxysilanes, and 3-methacryloxy-propyltrimethoxysilane.

A preferred class of such reactive silanes can be represented by the general formula

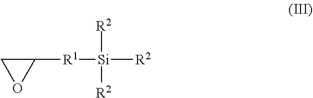

where R¹ and R² are defined as above. A representative general formula (III) compound is 3-glycidoxypropyhnethyldiethoxysilane, as well as similar compounds where the chain lengths or the alkylene spacer, the alkyl substituent and the alkoxy substituents are varied. Other representative general formula (III) compounds include mono- and tri-alkoxy analogs.

The amount of this type of covalent crosslinking agent generally is 1 to 5%, preferably from 1.25 to 3%, and even more preferably from 1.5 to 2.5% (all w/w, based on polymer solids).

The presence of covalent crosslinking agent typically does not eliminate the desirability of at least some ionic (metal) crosslinking agent, which can be included as a post-add or blended into the liquid composition at some later time but prior to application to a floor. Using zinc ammonium carbonate (ZAC, 18% equivalent ZnO content) as an exemplary ionic cross-linker, common amounts are from 1.25 to 2 pph and typical amounts are from 1.33 to 1.75 pph.

The covalent crosslinking agent generally enhances alcohol resistance of floor care coatings but often at the cost of reduced removability, while the opposite is true for the ionic crosslinking agent. These and other end use characteristics of floor coatings prepared using an interpolymer of the present invention with varying amounts of the two types of crosslinking agents (CoatOSil™ 2287 silane from Momentive Performance Materials Inc. (Waterford, N.Y.) as the covalent crosslinking agent and ZAC as the ionic crosslinking agent) are summarized in the following table, where amounts of crosslinkers are provided in weight percentages; “Application” is a combination of leveling, gloss, mop drag, ghosting and overall finish appearance; “Resistance” is a combination of performance in connection with each of 70% isopropanol, 70% ethanol, PureII™ hand sanitizer (GoJo Industries Inc.; Akron, Ohio) and Sterillium Comfort Gel™ hand sanitizer (Medline Industries, Inc.; Mundelein, Ill.); “Removability” is a composite of ease of removal using a commercially available, high pH solution and AS™ D1792 stripping solution; “Durability” is a combination of resistances to damage and scuffs from general foot traffic, micro scratching, abrasion, and dirt pick-up; “Reparability” is an indication of response to burnishing at 1500 rpm or higher.

TABLE 1
effect of crosslinkers on coating properties

| | | | | | |
|---|---|---|---|---|---|
| Covalent crosslinker | 2.00 | 2.00 | 1.60 | 1.20 | 1.20 |
| Ionic crosslinker | 1.52 | 1.80 | 1.66 | 1.52 | 1.80 |
| Application | 4.7 | 4.9 | 4.7 | 4.8 | 4.6 |
| Resistance | 3.9 | 3.6 | 3.6 | 3.4 | 3.4 |
| Removability | 4.3 | 4.3 | 4.8 | 4.8 | 4.9 |
| Durability | 3.5 | 3.8 | 3.3 | 4 | 3.8 |
| Reparability | 4.3 | 3 | 4.5 | 4.8 | 5 |
| 20° Gloss—4 coats | 29.8 | 33.2 | 31.5 | 30.3 | 36.1 |
| 60° Gloss—4 coats | 68.4 | 70.9 | 70.5 | 68.7 | 73.3 |

(The listed numerical ratings are based on the mean of several measurements for each.)

Using the foregoing as a guide, the ordinarily skilled artisan can adjust the amounts of each so as to achieve the desired levels of each of the two properties in a floor care composition.

If not added previously or if more is desired, one or more coalescents can be included in this post-add phase. An exemplary coalescent can have the effect of lowering the MFFT of a polymer composition that contains the coalescent and can preferably volatilize out of the polymer composition upon formation of a film and curing. Specific examples of coalescents include alcohols such as ethanol, isopropyl alcohol, etc., as well as polyols and glycol ethers. Useful amounts of coalescent based on total weight of a polymer finish composition can be amounts up to ˜10 weight percent coalescent based on total polymer finish composition, commonly from ˜1 to ˜7 weight percent, and typically from ˜3 to ˜5 weight percent.

Often, the contents of the polymerization vessel are collected and transported as is, i.e., as an aqueous emulsion. Such compositions can be stored at a temperature of from ˜5° to 50° C. without significant precaution; freezing of the composition preferably is avoided. The composition can be stirred prior to use.

The composition can be used as a base for a floor care composition, which also can include other solid or liquid ingredients useful in such coating applications. Exemplary additives are those which produce a desired physical property or effect in a polymer finish composition or dried derivative thereof, such as a film-forming property, a leveling property, chemical or physical (e.g., mechanical) stability of a composition, chemical reactivity upon cure or drying, compatibility between ingredients, viscosity, color, durability, hardness, finish (e.g. high gloss or matte finish), or another mechanical or aesthetic property, etc. Examples of added ingredients useful to achieve a desired effect can include additional polymers, surfactants, pigments, leveling agents (particularly fluorosurfactants), stabilizers, antifoam or de-foaming agents, waxes, plasticizers, coalescents, diluents, antimicrobial agents or other preservatives, and the like.

Exemplary descriptions of such compositions and their production can be found in U.S. Pat. Nos. 3,328,325, 3,467,610, 3,554,790, 3,573,329, 3,711,436, 3,808,036, 4,150,005, 4,517,330, 5,149,745, 5,319,018, 5,574,090, 5,676,741 and 6,228,913, as well as subsequent patent documents citing these. An exemplary floor care composition is provided in the Examples section which follows.

The non-volatile solids content of such floor care compositions can be ˜20%, ˜18%, ˜15%, or even as little as ˜5%, and can be up to ˜25%, ˜30%, ˜35%, or even ˜40%. (Various ranges resulting from combinations of lower and upper limits are envisioned.)

A floor care composition can be used to provide coatings to floors made of wood, wooden materials, synthetic resins, concrete, marble, stone and the like.

In use of a floor care composition, a floor can be coated, and thereby protected, by applying the floor care composition to a floor substrate and allowing the coating to dry in air or by heating; application of the floor care composition can be by fabric coating, brush spraying, brushing, etc., advantageously, at or about room temperature. Such coated floors can exhibit advantageous water resistance, scratch resistance, a desired degree of gloss (e.g., from semi-gloss to matte finish), and gloss retention. Additionally or optionally, the coated floor does not exhibit yellowing.

A floor care composition can be used to prepare a coated floor that has a coating (i.e., film) thickness of up to ˜70 μm, commonly from ˜5 to ˜50 μm, and typically from ˜10 to ˜30 μm. Film thickness can be developed over more than one application.

Certain embodiments of polymer finish compositions, such as floor care compositions, can exhibit useful or advantageously low viscosity, when measured at compounding and when measured immediately after compound, of a matter of hours or days after compounding, e.g., 10 days after compounding. Viscosity of a floor care composition may tend to increase after forming (e.g., “compounding”) the polymer finish composition from its constituent ingredients. Advantageously, embodiments of floor care compositions described herein can exhibit a reduced amount of this viscosity increase, with preferred measured values being below ˜60 cP, often below ˜50 cP.

Coatings provided from the aforedescribed composition of the invention can be characterized by a low haze value. Alternatively or in addition, floor care coatings can be characterized by good adhesion to particular substrates, including terrazzo, granite, marble, and ceramic tile.

Importantly, the type of coating just described can exhibit resistance to marring by alcohols such as isopropanol and, particularly, ethanol (including ethanol-containing hand sanitizing liquids and gels). Such resistance can be determined after permitting a liquid to remain on the coating until evaporation or, in the case of alcohol-containing gels, by permitting a 15-, 30- or 60-minute dwell time before performing a visual inspection.

Advantageously, this resistance to alcohol does not come at the cost of easy removability. As a so-called 1K-type system, the coating can be removed with typical caustic stripping solutions, even those having somewhat lower pH values.

Additionally, both of the foregoing are achieved without negatively impacting resistance to heel marks and abrasion.

While various embodiments of the present invention have been provided, they are presented by way of example and not limitation. The following claims and their equivalents define the breadth and scope of the inventive methods and compositions, and the same are not to be limited by or to any of the foregoing exemplary embodiments.

The following non-limiting, illustrative examples provide detailed conditions and materials that can be useful in the practice of the present invention.

### EXAMPLES

To a 2 L round bottom flask fitted with a temperature probe, condenser, monomer inlet, initiator inlet, N2 source, and a pitched turbine blade (set to 250-350 rpm) were added the materials shown below in Table 3. The flask was heated to a target internal temperature of 85° C., and ambient air was flushed with N₂.

When the internal temperature reached the preset temperature, the primary initiator components (Table 4) were added. After ˜5 minutes, the first phase of monomers (Table 5) was added over the course of ˜120 minutes at a pump rate of ˜5.8 g/min, with the target temperature being maintained.

After a delay of ˜15 min, the second phase of monomers (Table 6) was added over the course of ˜120 minutes at a pump rate of ˜2.3 g/min, with an internal temperature of 80° to 85° C. being maintained. Simultaneously, the secondary initiator components (Table 4) were added over the course of 75 minutes.

After the entirety of the second phase of monomers was added, the contents of the reactor were allowed to stir for approximately an hour, after which the reactor contents were allowed to cool to ˜60° C. before half of the mixture delineated as REDOX #1 in Table 7 was added. After ˜5 minutes, half of the mixture delineated as REDOX #2 in Table 5 was added. The reactor contents were allowed to stir for ˜30 minutes.

The other half of the REDOX #1 mixture was added and, after ˜5 minutes, the other half of the REDOX #2 mixture was added. The reactor contents were allowed to stir for ˜30 minutes.

The reactor contents were permitted to cool to ˜40° C. before 62.75 g ZAC was added directly. The reactor contents were permitted to mix for at least 15 minutes before 28.4 g of a pre-mixed combination of equal amounts of Benzoflex™ 2088 plasticizer (Eastman Chemical Co.; Kingsport, Tenn.) and CoatOSil™ 2287 epoxysilane were added, after which the reactor contents were allowed to stir for ˜30 minutes.

The contents of the reactor were filtered through a 325 mesh screen (0.044 mm openings), resulting in a solids recovery of ˜762.5 g (38.1% solids).

The properties of the polymer particle products are summarized in Table 8. The Brookfield viscosity value was obtained at room temperature using a RV-2 spindle at 20 rpm.

In the following tables, Calsoft™ L-40 sodium linear alkylbenzene sulfonate surfactant is available from Pilot Chemical Co. (Cincinnati, Ohio); Disponil A 1080 ethoxylated linear fatty alcohols is available from BASF (Ludwigshafen, Germany); and Bruggolite™ FF6M sodium salt of an organic sulfinic acid derivative is available from L. Brüggemann GmbH & Co. KG (Heilbronn, Germany).

TABLE 3
initial reactor charge

| Component | Amount (g) |
|---|---|
| deionized water | 760.33 |
| dipropylene glycol n-butyl ether | 7.10 |
| sodium bicarbonate | 0.60 |
| Calsoft ™ L-40 | 10.65 |
| TOTAL | 778.68 |

TABLE 4
initiator charges

| | Amount (g) | |
|---|---|---|
| Component | Initial | Secondary |
| deionized water | 29.75 | 29.35 |
| ammonium persulfate | 4.00 | 1.00 |
| TOTALS | 33.75 | 30.35 |

TABLE 5
initial monomer charge

| Component | Amount (g) |
|---|---|
| deion.ized water | 253.25 |
| Disponil ™ A 1080 | 1.78 |
| Calsoft ™ L-40 | 3.55 |
| styrene | 11.72 |
| butyl acrylate | 213.00 |
| methacrylic acid | 56.80 |
| methyl methacrylate | 156.20 |
| TOTAL | 696.30 |

TABLE 6
secondary monomer charge

| Component | Amount (g) |
|---|---|
| acrylonitrile | 71.00 |
| styrene | 201.29 |
| TOTAL | 272.29 |

TABLE 7
redox components

| | Amount (g) | |
|---|---|---|
| Component | REDOX #1 | REDOX #2 |
| deionized water | 45.41 | 45.77 |
| Disponil ™ A 1080 | 0.89 | 0.89 |
| ammonia (19%) | 1.25 | 1.25 |
| tert-butyl hydroperoxide (70%) | 1.20 | — |
| Bruggolite ™ FF6 M | — | 0.84 |
| TOTALS | 48.75 | 48.75 |

TABLE 8
polymer properties

| Property | Value |
|---|---|
| pH | 7.9 |
| Brookfield viscosity | 25.0 |
| MFFT (° C.) | 40 |
| % solids | 38.5 |
| average particle diameter (nm) | 98.5 |
| turbidity (1 mm) | 37.3 |
| % sediment | <0.05% |
| T_{g} values* (° C.) | 29.2, 103.1 |
| amount of Zn (by wt.), titrated | 0.55% |

*As evidenced by peaks on differential scanning calorimetry measurements

Based on monomer feed amounts, the weight percentage of the resulting polymer particles resulting from each of the monomers employed is as follows:

| | |
|---|---|
| butyl acrylate | 30 |
| methyl methacrylate | 22 |
| methacrylic acid | 8 |
| acrylonitrile | 10 |
| styrene | 30 |

Assuming 100% conversion, this provides the resulting polymer particles with 8 pph carboxyl group-containing mer.

The emulsion polymerization composition was validated through inclusion in a floor care composition.

The materials used in the floor care composition, as well as the manner in which they were added, are shown below in Table 9. In that table, Silfoam™ SE 21 antifoam agent is available from Wacker Chemical Corp. (Adrian, Mich.), Acticide™ MBS biocide is available from Thor Specialties Inc. (Shelton, Conn.), Capstone™ FS-61 fluorosurfactant (1% active) is available from The Chemours Company FC, LLC (Wilmington, Del.), and Mor-FIo™ WE 30 HDPE emulsion and Mor-FIo™ WE 40 copolymer wax emulsion are available from OMNOVA Solutions Inc. (Beachwood, Ohio). The product of the above-described emulsion polymerization is identified as “XL emulsion.”

The properties of this floor care composition are summarized in Table 10. Brook-field viscosity was obtained at room temperature (˜21° C.) using a RV-1 spindle at 50 rpm.

TABLE 9
floor care composition ingredients

| Component | Amount (wt. %) |
|---|---|
| water | 30.12 |
| Silfoam ™ SE 21 | 0.01 |
| di ethylene glycol monoethyl ether | 4.47 |
| tributoxyethyl phosphate | 0.89 |
| Acticide ™ MBS | 0.10 |
| Capstone ™ FS-61 | 0.75 |
| mix for 10 minutes | |
| XL emulsion | 58.74 |
| mix/or 10 minutes | |
| Mor-Flo ™ WE 30 | 3.57 |
| Mor-Flo ™ WE 40 | 1.35 |
| mix for 10 minutes | |
| TOTAL | 100.00 |

TABLE 10
floor care composition properties

| Property | Value |
|---|---|
| pH | 7.9 |
| Brookfield viscosity | 7.85 |
| % solids | 25 |

For performance testing, this floor care composition was applied using a flat, microfiber floor finish applicator to a test floor of known area at 2 mL/ft.² (21.5 mL/m²), an amount that approximates that which is necessary to provide a 0.20-0.25 mil (5 to 6.5 μm) coating thickness using 1 gallon (˜3.8 L) per 1500-2000 ft.² (˜140 to ˜186 m²).

A total of 5 applications were made sequentially, thereby providing a total coating thickness of 1-1.25 mil (˜25 to ˜32 μm).

The resulting floor care coating had acceptable shoe mar/scuff resistance, scratch and abrasion resistance, detergent (quaternary ammonia type) resistance, and reparability; good initial gloss, and very good soil resistance. Compared to coatings resulting from several commercially marketed floor care compositions, the subject floor care composition provided a competitive coating.

Where the subject floor care composition excelled, however, was a balance between alcohol resistance (as determined by visual inspection and colorimeter) and ease of removal. When compared against other 1K systems, the subject floor care composition provided a coating with a competitive level of removability but a far greater amount of alcohol resistance. Conversely, when compared against 2K systems, the subject floor care composition provided a coating with a competitive level of alcohol resistance but a far greater level of removability.

1. A floor care composition, comprising:
a) water;
b) an effective amount of one or more dispersing agents;
c) from 1 to 5 weight percent of a non-ionic crosslinking agent; and
d) from 34 to 42 weight percent internally plasticized polymer particles, wherein said particles comprise two types of polymers or of polymer segments, the first of which lies predominantly within a layer of, yet is at least partially penetrated by, the second of which, wherein each of the following is true:
(i) relative to the total weight of polymers in said particles,
(A) said first type constitutes from 56 to 66 weight percent and
(B) said second type constitutes from 34 to 44 weight percent,
(ii) the glass transition temperatures of said first and second types are, respectively, less than 40° C. and at least 75° C.,
(iii) the total amount of mer units that comprise carboxyl groups in said polymer particles, based on dry polymer weight, is less than 9 pph, and
(iv) all mer units that comprise carboxyl groups are in said first type.

2. The floor care composition of claim 1 wherein said non-ionic crosslinking agent comprises a reactive silane defined by the general formula Z-R¹-Si(R²)₃ where Z is a reactive functional group, R¹ is a divalent linking group, and each R² independently is an alkyl or alkoxy group, with the proviso that at least one R² is an alkoxy group.

3. The floor care composition of claim 2 wherein at least two R² moieties are alkoxy groups.

4. The floor care composition of claim 2 wherein Z is an epoxide group.

5. The floor care composition of claim 1 wherein, relative to the total weight of polymers in said particles, said first type constitutes from 58 to 64 weight percent and said second type constitutes from 36 to 42 weight percent.

6. The floor care composition of claim 5 wherein, relative to the total weight of polymers in said particles, said first type constitutes from 59 to 63 weight percent and said second type constitutes from 37 to 41 weight percent.

7. The floor care composition of claim 6 wherein, relative to the total weight of polymers in said particles, said first type constitutes from 60.5 to 62.5 weight percent and said second type constitutes from 37.5 to 39.5 weight percent.

8. The floor care composition of claim 1 wherein the total amount of mer units that comprise carboxyl groups in said polymer particles, based on dry polymer weight, is at least 6 pph.

9. The floor care composition of claim 8 wherein the total amount of mer units that comprise carboxyl groups in said polymer particles, based on dry polymer weight, is from 7.6 to 8.4 pph.

10. The floor care composition of claim 1 wherein said first type comprises at least one (meth)acrylate represented by the general formula 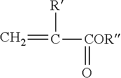
where R¹ is H or a methyl group and R″ is a C₁-C₁₈ alkyl group.

11. The floor care composition of claim 10 wherein R″ is a C₁-C₈ alkyl group.

12. The floor care composition of claim 10 wherein said first type further comprises a vinyl ester or an α-olefin.

13. The floor care composition of claim 10 wherein said first type further comprises from 1 to 4 weight percent, based on the total mer in said first type, of at least one vinyl aromatic compound.

14. The floor care composition of claim 1 further comprising 1.25 to 2 pph ionic crosslinking agent.

15. The floor care composition of claim 1 further comprising coalescent in an amount of from more than zero to 10 weight percent, based on the total weight of said composition.

16. A method for protecting a floor, said method comprising applying the floor care composition from claim 1 and allowing said interpolymer particles to coalesce so as to provide a floor protective coating.

17. A process for preparing an aqueous dispersion of interpolymer particles, said method comprising:
a) to a vessel containing water and at least one dispersing agent, adding in either ordera first monomer charge and a catalyst system, wherein the monomers of said first monomer charge comprise
1) from 7.5 to 17.5 weight percent, based on the total weight of monomers in said first monomer charge, of ethylenically unsaturated compounds that comprise a hydroxyl group, and
2) at least one (meth)acrylate;
b) permitting the catalyst system to initiate polymerization of the monomers in said first monomer charge, thereby providing a first type of polymer or segment of polymer;
c) to said vessel, adding a second monomer charge and, optionally, an additional amount of catalyst system, wherein the monomers of said second monomer charge are free of ethylenically unsaturated compounds that comprise a hydroxyl group and comprise only monomers which homopolymerize to polymers having glass transition temperatures of at least 75° C.; and
d) permitting said catalyst system to initiate polymerization of the monomers in said second monomer charge, thereby providing a second type of polymer or segment of polymer,
thereby providing said interpolymer particles, wherein the ratio of said first monomercharge to said second monomer charge ranges from 56:44 to 66:34.

18. The method of claim 17 wherein said second type of polymer or polymer segment interrupts or penetrates said first type of polymer or polymer segment.

19. The method of claim 17 wherein said ratio of said first monomer charge to said second monomer charge ranges from 59:41 to 63:37.

20. The method of claim 19 wherein said ratio of said first monomer charge to said second monomer charge ranges from 60.5:39.5 to 62.5:37.5.
